(19) United States
(12) Patent Application Publication
(10) Pub. No.: US 2022/0205371 A1
(43) Pub. Date: Jun. 30, 2022

(54) CAMSHAFT AND VALVE ACTUATION MECHANISM OF ENGINE

(71) Applicant: TENGFEI JI, WUXI (CN)

(72) Inventor: TENGFEI JI, WUXI (CN)

(21) Appl. No.: 17/594,770

(22) PCT Filed: May 15, 2020
(86) PCT No.: PCT/CN2020/090458

§ 371 Date: Oct. 28, 2021

(30) Foreign Application Priority Data
May 21, 2019 (CN) 201910423341.2

(51) Int. Cl. F01L 13/00; F01L 1/047; F01L 1/18

(52) U.S. Cl. CPC F01L 13/0036; F01L 9/16; F01L 1/18; F01L 1/047

(57) ABSTRACT

This invention is a camshaft and a valve actuation mechanism of an engine. The camshaft includes a first cam and a second cam that are adjacently arranged for an intake or exhaust rocker arm. A flange is arranged between the two cams, and is positioned at a position with a lift of the first cam and the second cam. No flange is arranged in a B section where both of the cams are base circles. When the rocker arm roller is shifted to another cam, since blocking of the flange between the two cams, shifting may be performed when the camshaft is rotated to a position where both of the cams are base circles, which ensures reliability. In addition, one solenoid may control a plurality of actuators, and thus the cost is low. The two cams may implement the functions of the engine, such as, variable valve or engine brake or others.

### CROSS-REFERENCE TO RELATED APPLICATIONS

This application is a 371 of International Patent Application Number PCT/CN2020/090458, filed on May 15, 2020, which claims the benefit and priority of Chinese Patent Application Number 201910423341.2, filed on May 21, 2019 with China National Intellectual Property Administration, the disclosures of which are incorporated herein by reference in their entireties.

### TECHNICAL FIELD

The present disclosure relates to the technical field of engines, and in particular, relates to a camshaft and a valve actuation mechanism of an engine.

### BACKGROUND

A variety of engine variable valve technologies are well known and available at present. Various variable valve technologies achieve variable valve lift or valve timing by different structural designs and control methods, such that the engine achieves better performance or implement special functions. One of the known variable valve technologies is to arranged two cams with different profiles on the camshaft of an engine, and cause a valve actuation mechanism to be shifted between the two cams according to the actual needs. In this way, the engine obtains two different valve lifts to improve engine performance or achieve a special function such as engine brake.

For such a variable valve mechanism in which shifting between the cams is supported, a design that has been disclosed is that for a rocker arm mechanism with a roller follower, the rocker arm roller is made to have a slidable function on the roller shaft, such that the variable valve is implemented by contact of the roller with different cams.

However, due to high speed of the engine, the most critical problem that the variable valve actuation mechanism in which shifting between cams is supported needs to solve is that: The shifting needs to be completed in an extremely short time period, and in the shifting process, the roller is reliably in contact with different cams for shifting when the two cams are in the base circle portion. If any of the cams is not in the base circle portion, the shifting may fail or impacts and damages are caused to the valve system due to abrupt variations of the valve lift. This is a great challenge. Some of the currently published design schemes use hydraulic actuation, or use spiral groove actuation on the camshaft. However, the structure is often complicated, the cost is high, or it is difficult to ensure that the roller may not be shifted between and in contact with different cams within a specific cam angle, and operating reliability is poor.

### SUMMARY

The present disclosure provides a camshaft of an engine and a valve actuation mechanism equipped with the camshaft. The mechanism achieves variable valves by sliding a roller to be in contact with different cams. In the present disclosure, the camshaft structure and the valve actuation mechanism are specially designed, such that it is ensured that the roller is reliably shifted between different cams and in contact with the cams. In addition, the present disclosure has the merits of simple design, low cost, and ease of applicability.

The camshaft according to the present disclosure includes two adjacent cams with different profiles, which are arranged for an intake or exhaust rocker arm of at least one cylinder. A flange higher than surfaces of profiles of the cams is arranged between the two cams. The flange is positioned at any cam with a lift of the two cams, and no flange is arranged at a position where both of the cams are base circles.

Embodiments of the present disclosure provide a camshaft of an engine. The camshaft includes a first cam (11a) and a second cam (11b) that are adjacently arranged for an intake or exhaust rocker arm of at least one cylinder, wherein both the first cam (11a) and the second cam (11b) have a B section where both of the cams are base circles in a circumferential direction and have an identical diameter of base circle; and

a flange higher than surfaces of the profiles of the cams is arranged between the first cam and the second cam, the flange being positioned at a portion with a lift of the first cam and the second cam, the flange being higher than the surface of the profile of any of the cams along the profiles of the two cams, no flange being arranged in the B section; or no flange is arranged between the first cam (11a) and the second cam (11b), a recessed arc-shaped or groove-shaped structure being arranged on surfaces of profiles of the cams, or a protrusive arc-shaped or flange structure being arranged on surfaces of profiles of the cams.

A valve actuation mechanism of an engine is further provided. The valve actuation mechanism includes the camshaft as described above, a rocker arm mechanism, a rocker arm shaft, and a control mechanism; wherein the rocker arm mechanism includes a roller follower, a width of a portion of the rocker arm mechanism, where the roller follower is mounted, in an axial direction of the roller follower being greater than a thickness of the roller follower, an exhaust rocker arm roller being mounted on a roller shaft and being axially slidable, a leftward and rightward slidable distance being equal to a distance from a center of the first cam to a center of the second cam;

wherein the control mechanism further includes an actuator, a solenoid valve, an electronic control unit (ECU) of the engine, and a connecting pipeline, the actuator being connected to compressed air of a vehicle via the connecting pipeline, the connecting pipeline being connected to at least one actuator, a solenoid valve being arranged on the connecting pipeline, the solenoid valve being configured to control connection or disconnection of the connecting pipeline;

wherein the solenoid valve is connected to the ECU of the engine, the ECU of the engine is configured to receive a camshaft position sensor signal, and the ECU of the engine is further configured to control a power on or power off moment of the solenoid valve based on the camshaft position sensor signal.

Further, the actuator includes a cylindrical actuator body, an actuation piston being arranged in an inner bore of the actuator body, a fitting clearance being defined between the actuation piston and the inner bore of the actuator body, the actuation piston being slidable in the inner bore of the actuator;

wherein a return spring is arranged on one end of the actuation piston, end caps are mounted on two ends of the actuator, a joint is arranged on one side of the actuator body, the joint being connected to the connecting pipeline, an elongated bore in communication with the inner bore is arranged at a middle portion of the actuator body, a fork is arranged on the actuation piston, one end of the fork being a U-shaped structure, the U-shaped structure being snapped on the rocker arm roller to actuate the rocker arm roller to move leftward and rightward, the other end of the fork being a cylindrical pin-shaped structure, a pin end of the fork running through the elongated bore and being pressed and fixed inside a pin bore at a middle portion of the actuation piston.

Further, the rocker arm roller and the roller shaft are assembled and fixed together by interference fitting, the roller shaft being clearance fitted into a roller shaft mounting bore such that the roller shaft is rotatable in the roller shaft mounting bore and axially slidable, a length of the roller shaft is greater than a distance between two roller shaft mounting bores, a axially slidable distance of the rocker arm roller and the roller shaft in the roller shaft mounting bore is equal to the distance from the center of the first cam to the center of the second cam, a groove-shaped shaft section with a decreasing diameter is arranged on one end of the roller shaft, and the actuator comprises a cylindrical actuator body, an actuation piston being arranged in an inner bore of the actuator body, a fitting clearance being defined between the actuation piston and the inner bore of the actuator body, the actuation piston being slidable in the inner bore of the actuator;

wherein a return spring is arranged on one end of the actuation piston, end caps are mounted on two ends of the actuator, a joint is arranged on one side of the actuator body, the joint being connected to the connecting pipeline, an elongated bore in communication with the inner bore is arranged at a middle portion of the actuator body, and a fork is arranged on the actuation piston, one end of the fork being a cylindrical pin-shaped structure and pressed and fixed into a pin bore of the actuation piston, the other end of the fork being a plate-shaped structure, an arc-shaped groove being arranged on the plate-shaped structure, an opening being arranged on one end of the arc-shaped groove and snapped to the groove-shaped shaft section on one end of the roller shaft, an arc portion of the arc-shaped groove taking an axial center of the rocker arm as a center of circle, an angle of the arc-shaped groove being not less than an angle by which the rocker arm roller swings from a position of the base circle to a position of a maximum lift, the fork being capable of pushing the roller shaft and the roller to slide leftward and rightward without affecting swinging of the rocker arm roller under the effect of the first cam and the second cam.

Further, the actuator includes a cylindrical actuator body, an end cap being arranged on one end of the actuator body, an air inlet being arranged on the end cap and connected to the pipeline, an actuation shaft bore being arranged on the other end of the actuator body, an actuation shaft being mounted on one end of the actuation piston, the actuation shaft running through the actuation shaft bore on the actuator body and extending to the outside, a fork being arranged on the actuation shaft, the fork being fixed to one end, extending to the outside, of the actuation shaft via a nut, a return spring being mounted between the actuation piston and the actuator body.

Further, no return spring is arranged on one end of the actuation piston of the actuator, a port is arranged on each of two ends of the actuator body, and the pipeline includes two pipes, which are respectively connected to the ports on the two ends of the actuator body.

Further, the pipeline is connected to a lubrication oil with a specific pressure in the engine, and the actuation piston is actuated, by lubrication oil to achieve shifting of the roller between two cams.

Embodiments of the present disclosure further provide a valve actuation mechanism. The valve actuation mechanism includes the camshaft as described above, a rocker arm mechanism, and a control mechanism. The rocker arm mechanism is a rocker arm with a roller, and a width of a space of the rocker arm mechanism, where the roller follower is mounted, is greater than a thickness of the roller follower in an axial direction of the roller follower, such that the rocker arm roller is axially slidable along the roller shaft to be shifted between and in contact with different cams on the camshaft. The control mechanism includes an actuator, a solenoid valve, and an ECU of the engine, the actuator being an actuation cylinder with an actuation piston, a fork being arranged on the actuation piston for connection to the rocker arm roller and configured to actuate the rocker arm roller to slide leftward and rightward, the actuator being connected to compressed air of the engine by a pipeline and actuating the rocker arm roller to slide by the compressed air, the solenoid valve being arranged on the pipeline, the solenoid valve being connected to the ECU of the engine, the ECU being configured to control power on or power off of the solenoid valve so as to control connection or disconnection of the compressed air and hence finally control sliding of the rocker arm roller.

When the engine desires the rocker arm roller to be shifted to be in contact with another cam, the ECU of the engine may power on the solenoid valve based on a cam angle position provided by the camshaft position sensor when the cam is rotated to have entered the B section with no flange, such that the actuation piston of the actuator actuates the rocker arm roller to slide to be in contact with another cam. In this way, the actuator may have a longest time to actuate the rocker arm roller to be shifted to another cam. In addition, since the rocker arm roller is lightweight and the pressure of the compressed air is high, by designing a suitable diameter for the actuation piston, it is ensured that the rocker arm roller is shifted within a specified time period.

In addition, with respect to a multi-cylinder engine, a plurality of actuators are needed to achieve sliding of rocker arm rollers. If a control solenoid is arranged for each actuator, the control mechanism is complicated and the cost is significantly increased. The most significant advantage of the present disclosure lies in that, while it is ensured that the two cams are both in the base circle portion during the shifting of the rocker arm roller between the cams, one solenoid valve may control the rocker arm rollers of the plurality of cylinders to reliably shift between the cams. The operating principles are as follows: Since the flange is arranged at a position where any of the two cams has a lift in the camshaft, when the cams of one cylinder is in the base circle portion, the cams of other cylinders are not in the base circle portion. The flange between two cams may block the shifting of the rocker arm roller between two cams, which prevents the case where the shifting fails because the rocker arm roller is shifted when the cam has a lift, and prevents impacts and damages to the valve system due to abrupt variation of the valve lift. The shifting is performed when the camshaft is rotated such that both of the cams are base circles. When the roller needs to be returned to be in contact with the original cam, the ECU controls the solenoid valve to be powered off in the same fashion. In this case, the actuation piston of the actuator is capable of actuating, by the return spring or the reverse compressed air, the rocker arm roller to return to be in contact with the original cam, thereby implementing variable valve lift.

In addition, as for the structure of the camshaft according to the present disclosure, other design schemes are also available for practice of shifting of the rocker arm roller when the two cams both have the base circle. Different design schemes are also available for the structure of the actuator and the fashion of actuating the rocker arm roller. The actuator may also be actuated by a hydraulic actuation source in addition to the pneumatic actuation. Details are given in the drawings and specific embodiments of the present disclosure.

### BRIEF DESCRIPTION OF THE DRAWINGS

FIG. 1 is a schematic structural view of a camshaft according to the present disclosure;

FIG. 2 and FIG. 3 are schematic structural views of other design solutions of the camshaft according to the present disclosure;

FIG. 4 is a schematic structural view of a valve actuation mechanism according to a first embodiment of the present disclosure (a pipeline, a solenoid valve, and an ECU are not included);

FIG. 5 is a schematic perspective view of a valve actuation mechanism according to a first embodiment of the present disclosure;

FIG. 6 is a schematic structural view of a state where a roller is shifted to another camshaft in the valve actuation mechanism according the first embodiment of the present disclosure;

FIG. 7 is a schematic structural view of a valve actuation mechanism according to a second embodiment of the present disclosure;

FIG. 8 is a perspective view along an axial direction of the camshaft in the valve actuation mechanism according to the second embodiment of the present disclosure (a pipeline, a solenoid valve, and an ECU are not included);

FIG. 9 is a schematic structural view of a valve actuation mechanism according to a third embodiment of the present disclosure; and

FIG. 10 is a schematic structural view of a valve actuation mechanism according to a fourth embodiment of the present disclosure.

### DETAILED DESCRIPTION

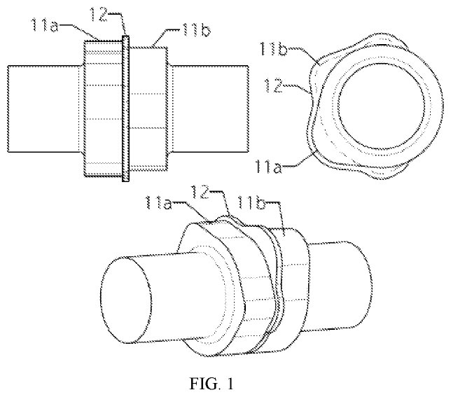

FIG. 1 illustrates a first design scheme of a camshaft according to the present disclosure. The camshaft includes two adjacent cams 11a and 11b arranged for an intake or exhaust rocker arm of at least one cylinder. The two cams have different profiles, and both have a B section where both of the cams are base circles in a circumferential direction and have an identical diameter of base circle. According to the needs of the engine, the two cams may be designed to implement different functions, such as, variable intake and engine brake. In addition, a flange 12 higher than surfaces of the profiles of the cams is arranged between the two cams 11a and 11b. The flange 12 is specifically positioned at a portion with a lift of the two cams, and the flange 12 is higher than the surface of the profile of any of the two cams along the profiles of the two cams. No flange is arranged in the B section where both of the cams are base circles.

For ease of manufacturability, in the B section where both of the cams are base circles, the position reserved for the flange is made to a groove. The camshaft achieves the following advantages: When the rocker arm roller is shifted between the two cams 11a and 11b, since the flange 12 between the two cams blocks the shifting of the rocker arm roller between the two cams, the rocker arm roller is prevented from being shifted at the position where the cams have a lift, and it is ensured that the rocker arm roller is shifted when the camshaft is rotated to the position where both of the cams are base circles.

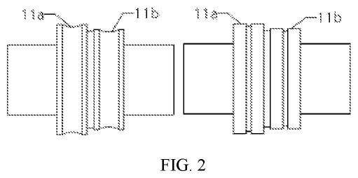

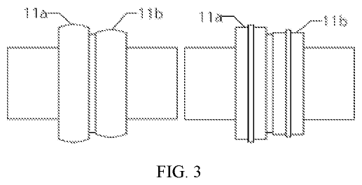

FIG. 2 and FIG. 3 illustrate other design schemes of the camshaft according to the present disclosure. The camshaft 1 includes two adjacent cams 11a and 11b arranged for an intake or exhaust rocker arm of at least one cylinder. As illustrated in FIG. 2 and FIG. 3, the two cams have different profiles, and have a B section where both of the cams are base circles in a circumferential direction and have an identical diameter of base circle. In the camshaft 1, no flange is arranged between the two adjacent cams 11a and 11b. Instead, recessed arc or groove structures are arranged on the surfaces of the profiles of the cams (as illustrated in FIG. 2), or protrusive arc-shaped or flange structures are arranged on the surfaces of the profiles of the cams (as illustrated in FIG. 3), and protrusive or recessed structures engaged with the surfaces of the cams are arranged on surfaces of the matched roller followers. In addition, a valve gap is defined to be greater than a depth or height of the recessed or protrusive structure. In this way, when the cam actuates the roller follower to move to have a lift, since a greater force between the cam and the roller, during axial sliding of the roller, the recessed or protrusive structure between the roller and the cam may block sliding of the roller, such that the roller fails to be slidably shifted to another cam. No force is generated between the cam and the roller when the cam is rotated to the B section where both of the cams are base circles. In addition, since the gap between the roller and the cam is greater than the depth or height of the recessed or protrusive structure, the recessed or protrusive structure between the roller and the cam may not block sliding of the roller, and thus the rocker arm roller is axially slidable to implement shifting, thereby ensuring reliability of the shifting.

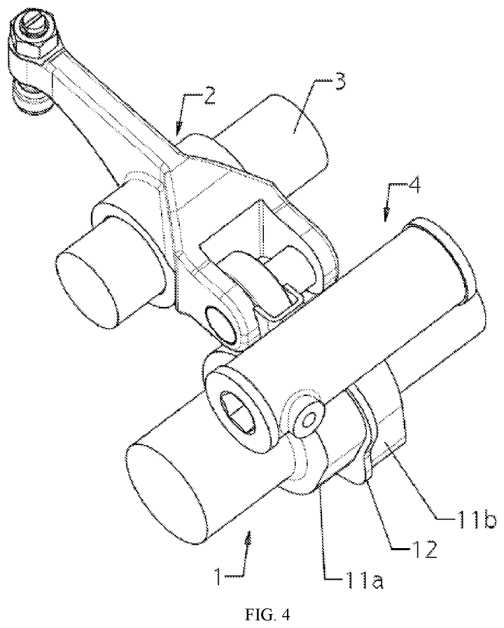

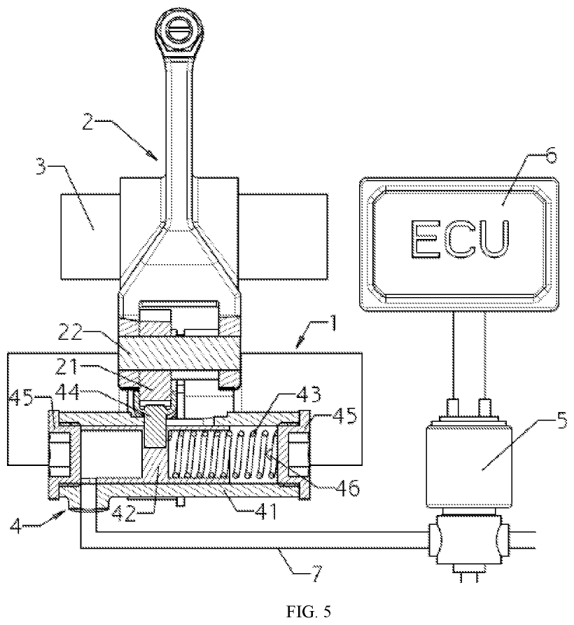

FIG. 4 and FIG. 5 illustrate a first embodiment of the valve actuation mechanism according to the present disclosure. In this embodiment, the valve actuation mechanism includes a camshaft 1, a rocker arm mechanism 2, a rocker arm shaft 3, and a control mechanism. FIG. 4 is schematic structural view of the valve actuation mechanism according to this embodiment (a pipeline, a solenoid valve, and an ECU are not included). FIG. 5 is a perspective view of the valve actuation mechanism according to this embodiment. The camshaft 1 is any of the camshafts described in the above three design schemes. The rocker arm mechanism 2 is a rocker arm with a roller follower which is mounted on the rocker arm shaft 3 and directly actuated by the camshaft 1. A width of a space of the rocker arm mechanism, where the roller follower is mounted, is greater than a thickness of the roller follower in an axial direction of the roller follower. An exhaust rocker arm roller 21 is mounted on a roller shaft 22, and is axially slidable. In addition, a leftward and rightward slidable distance is equal to a distance from a center of the cam 11a to a center of the cam 11b.

The actuation mechanism includes an actuator 4, a solenoid valve 5, an ECU 6, and a pipeline 7. As illustrated in FIG. 5, the actuator 4 is constituted by an actuator body 41, an actuation piston 42, a return spring 43, a fork 44, and end caps 45. The actuator body 41 is a cylindrical structure. The actuation piston 42 is arranged in an inner bore of the actuator body 41. A small fitting clearance is defined between the actuation piston 42 and the inner bore of the actuator body, such that the actuation piston is slidable in the inner bore of the actuator body. The return spring 43 is arranged on one end of the actuation piston 42. The end caps 45 are mounted on two ends of the actuator body 41. A bore 46 is arranged beneath one end of the return spring on the actuator body 41, such that the actuation piston exhaust air when moving leftward. A joint is arranged on the other side of the actuator body 41. The joint is connected to the pipeline 7. An elongated bore is arranged at a middle portion of the actuator body 41. The elongated bore is in communication with the inner bore. The fork 44 is arranged on the actuation piston 42. One end of the fork 44 is a U-shaped structure. The U-shaped structure is snapped on the rocker arm roller 21 to actuate the rocker arm roller to move leftward and rightward, without affecting swinging of the rocker arm roller under the effect of any of the cams. The other end of the fork 44 is a cylindrical pin-shaped structure. A pin end of the fork 44 runs through the elongated bore of the actuator body, and is pressed and fixed inside a pin bore at a middle portion of the actuation piston 42. One end of the pipeline 7 of the control mechanism is connected to compressed air of a vehicle, and the other end of the pipeline 7 is connected to at least one actuator 4. The solenoid valve 5 is arranged on the pipeline 7 to control connection or disconnection of the pipeline. When the solenoid valve 5 is powered, the pipeline 7 is connected to the pipeline of the compressed air of the vehicle. When the solenoid valve 5 is power interrupted, the pipeline 7 is disconnected from a pipeline of the compressed air of the vehicle, and is connected to atmospheric air. The solenoid valve 5 controls connection or disconnection between at least one actuator 5 and the compressed air. A terminal of the solenoid valve 5 is connected to the ECU 6 of the engine, and meanwhile, the ECU of the engine is connected to a camshaft position sensor. The ECU control a power on moment of the solenoid valve 5 based on a camshaft position signal output by the camshaft position sensor.

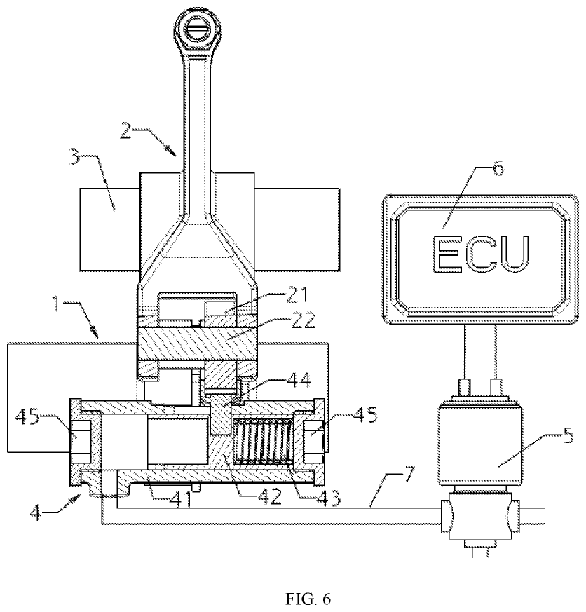

The operating principles and process of the mechanism are as follows: When the solenoid valve 5 is not powered on, as illustrated in FIG. 5, the pipeline 7 is disconnected to the pipeline of the compressed air of the vehicle and is connected to the atmospheric air, the actuation piston 42 in the actuator 4 is pushed to one end under the effect of the return spring 43, the fork 44 on the actuation piston pushes the roller 21 of the rocker arm mechanism 2 to one end to be in contact with the cam 11a, and the valve actuation mechanism of the engine opens or closes the valve under the effect of the cam 11a. In this case, the engine operates based on a valve lift generated by the cam 11a. When the engine needs to be shifted to operating based on a cam lift of the cam 11b, in response to a shift instruction, the ECU 6 first determine a position of the cam at this moment by the camshaft position sensor; and when the rocker arm roller 21 is rotated to has just entered or is about to enter the base circle portion, the B section, the ECU 6 powers on the solenoid valve 5. In this case, the pipeline 7 is connected to the pipeline of the compressed air of the vehicle, under the effect of the pressure of the compressed air, the actuation piston 42 overcomes the force of the return spring 43 and quickly moves, by the fork 44 on the actuator piston, the roller 21 to the other end to be in contact with the cam 11b, and during the movement, the air on the other side of the actuation piston may be exhausted by a vent hole arranged beneath the actuator body. As illustrated in FIG. 6, in this case, the engine operates based on a valve lift generated by the cam 11b. When the solenoid valve 5 controls a plurality of actuators 4, cam positions are determined according to an ignition sequence of the cylinders of the engine. When the ECU determines that the rocker arm roller controlled by the first actuator has just entered or is about to enter the base circle, that is, the B section, of the two cams, the rollers controlled by the other actuators are not in the B section. When the solenoid valve 5 is powered on such that the compressed air pushes the actuation piston 42 and hence the rocker arm roller 21 moves towards the other side, since the flange 12 higher than the surfaces of the profiles of the cams is arranged between the cam 11a and the cam 11b, except the B section, the roller 21 fails to move due to blocking by the flange 12. With rotation of the camshaft, when the rocker arm roller 21 enters the B section, since no flange is arranged on the B section, the actuation piston 42 is capable of pushing the roller 21 to quickly move to the other end to be in contact with the cam 11b, such that the engine operates based on the valve lift generated by the cam 11b. When the engine needs to return from the lift of the cam 11b to the lift of the cam 11a, the operating process is similar to the above described. In response to a shift instruction, the ECU 6 first determines the position of the cam at this moment by the camshaft position sensor. When the rocker arm roller 21 is rotated to have just entered or be about to enter the base circle, that is, the B section, of the two cams, the ECU 6 powers off the solenoid valve 5. In this case, the pipeline 7 is disconnected from the pipeline of the compressed air of the vehicle and is connected to the atmospheric air, and under the effect of the return spring 43, the actuation piston 42 quickly move, by the fork 44 on the actuation piston, the roller 21 to be in contact with the cam 11a. During the movement, the air on one side of the actuation piston is exhausted to the atmospheric air, the engine returns to the lift of the cam 11a, such that the engine can operate based on lifts of the two cams.

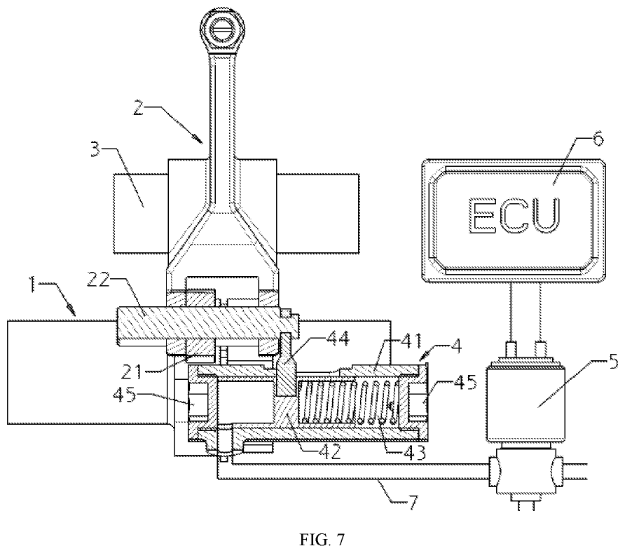

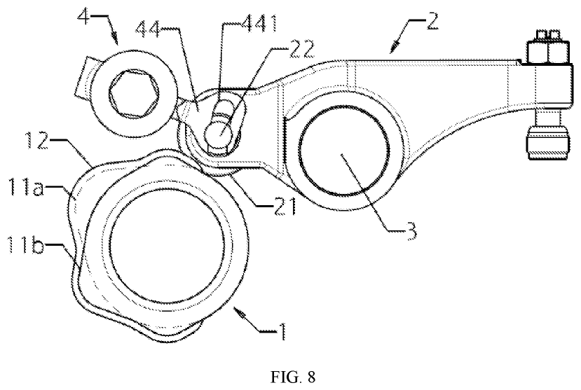

FIG. 7 and FIG. 8 illustrate a second embodiment of the valve actuation mechanism according to the present disclosure. In this embodiment, the difference over the first embodiment lies in the structure of the fork 44 on the actuation piston 42 and the structures of the rocker arm roller 21 and the roller shaft 22. In this embodiment, the rocker arm roller 21 and the roller shaft 22 are fitted and fixed together by interference fitting, the roller shaft 22 is clearance fitted into the roller shaft mounting bore of the rocker arm, such that the roller shaft 22 is rotatable in the roller shaft mounting bore and is axially slidable, a length of the roller shaft 22 is greater than a distance between two roller shaft bores, and an axial slidable distance of the rocker arm roller 21 and the roller shaft 22 in the roller shaft bore is equal to the distance between the cam 11a and the cam 11b. A groove-shaped shaft section with a decreasing diameter is arranged on one end of the roller shaft 22. One end of the fork 44 on the actuation piston 42 is a cylindrical pin-shaped structure, and is pressed and fixed into a pin bore of the actuation piston 42. The other end of the fork 44 is a plate-shaped structure. An arc-shaped groove 441 is arranged on the plate-shaped structure. An opening is arranged on one end of the arc-shaped groove 441 and snapped to the groove-shaped shaft section on one end of the roller shaft 22. The fork 44 is capable of pushing the roller shaft 22 and the roller 21 to slide leftward and rightward, and an arc portion of the arc-shaped groove 441 on the fork 44 takes a center of the rocker arm shaft as a center of circle. An angle of the arc-shaped groove is not less than an angle by which the rocker arm roller 21 swings from a position of the base circle to a position of a maximum lift. Therefore, the fork 44 does not affect swinging of the rocker arm roller 21 under the effect of any one of the cams. The other structures are the same as those in the first embodiment. In this embodiment, shifting of the roller between the two cams is practiced by actuating the roller shaft 22 and the roller 21 by the fork 44 to move leftward and rightward, and the operating principles and process are the same as those in the first embodiment.

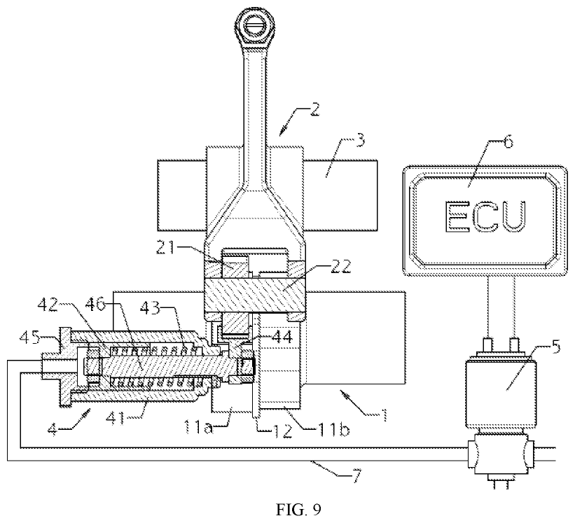

FIG. 9 illustrates a third embodiment of the valve actuation mechanism according to the present disclosure. In this embodiment, the different over the above embodiment lies in the structure of the actuator 4. As illustrated in FIG. 9, the actuator 4 includes a cylindrical actuator body 41. No elongated bore is arranged at a middle portion of the actuator body 41, and an end cap 45 is mounted on one end of the actuator body 41. An air inlet is arranged on the end cap, and is connected to the pipeline 7. An actuation shaft bore is arranged on the other end of the actuator body 41. An actuation shaft 46 is mounted on one end of the actuation piston 42. The actuation shaft 46 runs through the actuation shaft bore on the actuator body and extends to the outside. One end of the fork 44 is a U-shaped structure, and the other end of the fork 44 is a plate-shaped structure with a bore, which is fixed, by a nut, to the end of the actuation shaft 46 extending to the outside. A return spring 43 is mounted between the actuation piston and the actuator body. Shifting of the roller 21 between the two cams is practiced by actuating the fork 44 on the actuation shaft 46 to cause the roller 21 to slide. The operating principles and process are the same as those in the above embodiment. This structure is advantageous in that the length of the actuator body 41 is shortened, and the structure is more compact. Likewise, the structure of the actuator 4 in this embodiment may also be applicable to the shifting between the two cams by actuating the roller shaft 22 and the roller 21, by the fork 44, to move leftward and rightward, as described in the second embodiment.

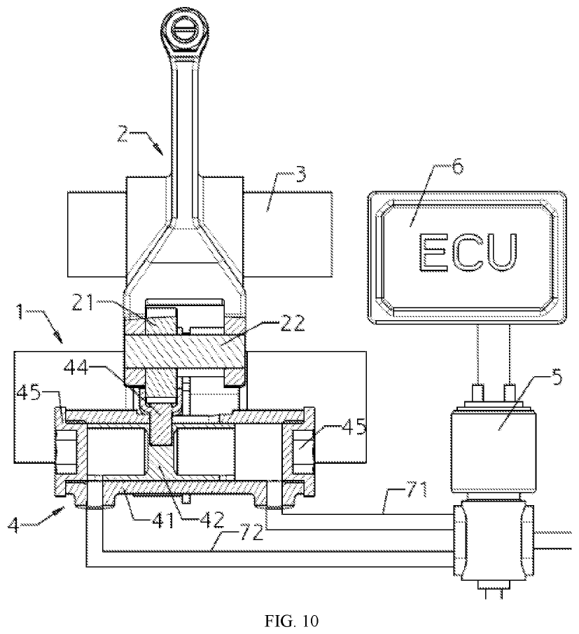

FIG. 10 illustrates a fourth embodiment of the valve actuation mechanism according to the present disclosure. In this embodiment, the difference over the above embodiment lies in the structure of the actuator 4. As illustrated in FIG. 10, no return spring is arranged on one end of the actuator 4 where the actuation piston 42 is arranged. A port is arranged on each end of the actuator body 41. The pipeline 7 includes a pile 71 and a pipe 72, which are respectively connected to the ports on two ends of the actuator body 41. When the solenoid valve 5 is powered off, the pipe 71 of the pipeline 7 is connected to the compressed air of the vehicle, and the pipe 72 of the pipeline 7 is connected to the atmospheric air. In this case, under the effect of the compressed air, the actuation piston 42 causes, by the fork 44, the rocker arm roller 21 to be in contact with the cam 11a. When the solenoid valve 5 is powered on, the pipe 72 is connected to the compressed air of the vehicle, and the pipe 71 is connected to the atmospheric air. In this case, the compressed air generates a counter force to the actuation piston 42. When the camshaft is rotated to the base circle, that is, the B section, such that the rocker arm roller 21 is shifted to be in contact with the cam 11b, this solution is advantageous in that leftward and rightward sliding of the actuation piston 42 is also achieved by actuation of the compressed air, and a response speed of the actuation piston may be improved. Likewise, the actuation fashion of the actuator 4 according to this embodiment is applicable to the above actuator structures in which the fork is mounted on the actuation piston 42 and the fork is mounted on the actuation shaft 46.

Further, the actuation fashion of the actuator 4 may be hydraulic actuation. The specific implementation solution is as follows: The pipeline 7 is connected to a lubrication oil pipeline with a specific pressure in the engine, the solenoid valve 5 controls connection or disconnection of the lubrication oil pipeline based on an instruction of the ECU, and the actuation piston 42 is actuated by lubrication oil to implement shifting of the roller between the two cams. The hydraulic actuation is applicable to all the above embodiments and the structures of the actuators 4 therein. The operating principles and process thereof are the same as those described above. This solution is advantageous in that there is no need to introduce the compressed air of the vehicle to the inside of the engine, and structural arrangement is convenient.

1. A camshaft of an engine, comprising: a first cam and a second cam that are adjacently arranged; wherein the first cam and the second cam have different profiles, and both have a B section where both of the cams are base circles in a circumferential direction and have an identical diameter of base circle; and
a flange higher than surfaces of the profiles of the cams is arranged between the first cam and the second cam, the flange being positioned at a portion with a lift of the first cam and the second cam, the flange being higher than the surface of the profile of any of the cams along the profiles of the two cams, no flange being arranged in the B section.

2. A valve actuation mechanism of an engine, comprising the camshaft as defined in claim 1, a rocker arm mechanism, a rocker arm shaft, and a control mechanism; wherein the rocker arm mechanism comprises a roller follower, a width of a portion of the rocker arm mechanism, where the roller follower is mounted, in an axial direction of the roller follower being greater than a thickness of the roller follower, an exhaust rocker arm roller being mounted on a roller shaft and being axially slidable, a leftward and rightward slidable distance being equal to a distance from a center of the first cam to a center of the second cam;
wherein the control mechanism further comprises an actuator, a solenoid valve, an electronic control unit (ECU) of the engine, and a connecting pipeline, the actuator being connected to compressed air of a vehicle via the connecting pipeline, the connecting pipeline being connected to at least one actuator, a solenoid valve being arranged on the connecting pipeline, the solenoid valve being configured to control connection or disconnection of the connecting pipeline;
wherein the solenoid valve is connected to the ECU of the engine, the ECU of the engine is configured to receive a camshaft position sensor signal, and the ECU of the engine is further configured to control a power on or power off moment of the solenoid valve based on the camshaft position sensor signal.

3. The valve actuation mechanism of the engine according to claim 2, wherein the actuator comprises a cylindrical actuator body, an actuation piston being arranged in an inner bore of the actuator body, a fitting clearance being defined between the actuation piston and the inner bore of the actuator body, the actuation piston being slidable in the inner bore of the actuator;
wherein a return spring is arranged on one end of the actuation piston, end caps are mounted on two ends of the actuator, a joint is arranged on one side of the actuator body, the joint being connected to the connecting pipeline, an elongated bore in communication with the inner bore is arranged at a middle portion of the actuator body, a fork is arranged on the actuation piston, one end of the fork being a U-shaped structure, the U-shaped structure being snapped on the rocker arm roller to actuate the rocker arm roller to move leftward and rightward, the other end of the fork being a cylindrical pin-shaped structure, a pin end of the fork running through the elongated bore and being pressed and fixed inside a pin bore at a middle portion of the actuation piston.

4. The valve actuation mechanism of the engine according to claim 2, wherein the rocker arm roller and the roller shaft are assembled and fixed together by interference fitting, the roller shaft being clearance fitted into a roller shaft mounting bore such that the roller shaft is rotatable in the roller shaft mounting bore and axially slidable, a length of the roller shaft is greater than a distance between two roller shaft mounting bores, a axially slidable distance of the rocker arm roller and the roller shaft in the roller shaft mounting bore is equal to the distance from the center of the first cam to the center of the second cam, a groove-shaped shaft section with a decreasing diameter is arranged on one end of the roller shaft, and the actuator comprises a cylindrical actuator body, an actuation piston being arranged in an inner bore of the actuator body, a fitting clearance being defined between the actuation piston and the inner bore of the actuator body, the actuation piston being slidable in the inner bore of the actuator;
wherein a return spring is arranged on one end of the actuation piston, end caps are mounted on two ends of the actuator, a joint is arranged on one side of the actuator body, the joint being connected to the connecting pipeline, an elongated bore in communication with the inner bore is arranged at a middle portion of the actuator body, and a fork is arranged on the actuation piston, one end of the fork being a cylindrical pin-shaped structure and pressed and fixed into a pin bore of the actuation piston, the other end of the fork being a plate-shaped structure, an arc-shaped groove being arranged on the plate-shaped structure, an opening being arranged on one end of the arc-shaped groove and snapped to the groove-shaped shaft section on one end of the roller shaft, an arc portion of the arc-shaped groove taking an axial center of the rocker arm as a center of circle, an angle of the arc-shaped groove being not less than an angle by which the rocker arm roller swings from a position of the base circle to a position of a maximum lift, the fork being capable of pushing the roller shaft and the roller to slide leftward and rightward without affecting swinging of the rocker arm roller under the effect of the first cam and the second cam.

5. The valve actuation mechanism of the engine according to claim 2, wherein the actuator comprises a cylindrical actuator body, an actuation piston being arranged in an inner bore of the actuator body, a fitting clearance being defined between the actuation piston and the inner bore of the actuator body, the actuation piston being slidable in the inner bore of the actuator, an end cap being arranged on one end of the actuator body, an air inlet being arranged on the end cap and connected to the pipeline, an actuation shaft bore being arranged on the other end of the actuator body, an actuation shaft being mounted on one end of the actuation piston, the actuation shaft running through the actuation shaft bore on the actuator body and extending to the outside, a fork being arranged on the actuation shaft, the fork being fixed to one end, extending to the outside, of the actuation shaft via a nut, a return spring being mounted between the actuation piston and the actuator body.

6-7. (canceled)
